(19) United States
(12) Patent Application Publication
(10) Pub. No.: US 2018/0017450 A1
(43) Pub. Date: Jan. 18, 2018

(54) NANO-CONDUCTIVE RUBBER SENSING UNIT AND PREPARATION METHOD THEREFOR

(71) Applicants: Shenzhen Municipal Design & Research Institute Co., Ltd., Shenzhen City (CN); Shenzhen Innova-Wise Engineering Technology Consulting Co., Ltd., Shenzhen City (CN)

(72) Inventors: Ruijuan JIANG, Shenzhen City (CN); Yiyan CHEN, Shenzhen City (CN); Weiming GAI, Shenzhen City (CN); Jucan DONG, Shenzhen City (CN); Fang YU, Shenzhen City (CN); Jie PENG, Shenzhen City (CN)

(21) Appl. No.: 15/289,140

(22) Filed: Oct. 8, 2016

(30) Foreign Application Priority Data
Jul. 18, 2016 (CN) 2016-10571308.0

(51) Int. Cl. G01L 1/18; B29C 70/44; B29K 105/16; B29K 83/00; B29K 507/04

(52) U.S. Cl. CPC G01L 1/18; B29C 70/443; B29K 2507/04; B29K 2083/00; B29K 2995/0005; B29K 2105/162

(57) ABSTRACT

The present invention discloses a nano-conductive rubber sensing unit and a preparation method therefor, which belong to the technical field of pressure measurement. The nano-conductive rubber sensing unit of the invention comprises at least two fabric layers, wherein nano-conductive rubber is filled between every two adjacent fabric layers, and the nano-conductive rubber is a rubber matrix in which carbon nanotubes are dispersed. The preparation method for the nano-conductive rubber sensing unit of the invention comprises: S1, mixing a rubber matrix with carbon nanotubes in accordance with a mass proportion so as to make a nano-conductive rubber slurry; S2, laying flat one fabric layer, spreading the nano-conductive rubber slurry prepared in S1 over the fabric uniformly to a certain thickness, and then, laying flat the other fabric layer thereon; and S3, pressurizing and heating the nano-conductive rubber sensing unit prepared in S2 to cure the same. The nano-conductive rubber sensing unit of the invention achieves the technical effects of a large measuring range of pressure measurement, high sensitivity in the measuring range and good linearity of a piezoresistance characteristic curve, and can meet the requirement of a sheet type.

### FIELD OF THE INVENTION

The present invention relates to the technical field of pressure measurement, and particularly relates to a nano-conductive rubber sensing unit and a preparation method therefor.

### BACKGROUND OF THE INVENTION

Nano-conductive rubber is a composite material which generates electrical conductivity after a nanoscale conductive filler is added in an insulating rubber matrix. As the nano-conductive rubber has good piezoresistance characteristics, durability, fatigue resistance and flexibility, it has been researched extensively to be used as a pressure sensing material, and has been applied in the fields of robots, medical care, spaceflight, etc.

Research shows that when the nano-conductive rubber is used as a pressure sensitive material, the measuring range thereof is related to the thickness, hardness, conductive filler proportion and manufacturing process of the conductive rubber. By increasing the thickness and hardness of the nano-conductive rubber, the measuring range thereof can be increased in a suitable amount. However, the thickness of a sheet-type pressure sensor is limited frequently in some workplaces, thus the thickness of the nano-conductive rubber is limited. Moreover, a thicker nano-conductive rubber material may be torn under the effect of a higher pressure due to a larger horizontal deformation, thus sufficient mechanical strength cannot be achieved. It is an effective way to improve the conductivity and mechanical performance thereof by optimizing the composition proportion of the nano-conductive rubber or adding a modifying material and a strengthening agent. The Chinese patent publication CN 104893291 A discloses a preparation method for a silicone rubber-base force sensitive composite material, in which nanoscale metal particles are used as a filler, and the maximum pressure intensity measuring value is 2.4 MPa. In addition, by experiments, some scholars also proved that the conductivity and pressure sensitive range of the composite material can be improved effectively by adding nano SiO₂ and nano Al₂O₃.

At present, for the research of the nano-conductive rubber, carbon-black filling type conductive rubber is used as a main type, most pressure sensors based on the nano-conductive rubber are in an experimental stage, some nano-conductive rubber sensors obtaining industrial application cannot yet realize the pressure measurement in the state of large pressure intensity in the fields of machinery, civil engineering, etc. due to the limitation of sensitivity, linearity and measuring range.

### SUMMARY OF THE INVENTION

The technical problem to be solved in the invention is to provide a nano-conductive rubber sensing unit which has a large measuring range of pressure measurement, high sensitivity within the measuring range and good linearity of a piezoresistance characteristic curve, and can meet the requirement of a sheet type.

The technical problem to be solved in the invention is also to provide a method for preparing the nano-conductive rubber sensing unit.

In order to solve the technical problems, the invention adopts the following technical solution.

The invention provides a nano-conductive rubber sensing unit, which comprises at least two fabric layers, wherein nano-conductive rubber is filled between every two adjacent fabric layers, and the nano-conductive rubber is a rubber matrix in which carbon nanotubes are dispersed.

As a further improvement to the technical solution, the carbon nanotubes are multi-wall carbon nanotubes.

As a further improvement to the technical solution, the mass percent of the multi-wall carbon nanotubes in the nano-conductive rubber is between 8% and 9%.

As a further improvement to the technical solution, the nano-conductive rubber is infiltrated into fiber texture gaps of the fabric layers.

As a further improvement to the technical solution, the rubber matrix is a silicone rubber, and the proportion of basic constituents of the silicone rubber to a curing agent is 10:1.

The invention also provides a preparation method for preparing the nano-conductive rubber sensing unit as mentioned above, which comprises the following steps: S1, mixing a rubber matrix with carbon nanotubes in accordance with a mass proportion so as to make a nano-conductive rubber slurry; S2, laying flat one fabric layer, spreading the nano-conductive rubber slurry prepared in S1 over the fabric uniformly to a certain thickness, and then, laying flat the other fabric layer thereon; and S3, pressurizing and heating the nano-conductive rubber sensing unit prepared in S2 to cure the same.

As a further improvement to the technical solution, in step S2, the fabric layer located at a bottom layer is laid flat on a bottom plate of a mould, and a top plate of the mould is placed on the fabric layer located at a top layer; and in step S3, pressures are exerted on the nano-conductive rubber sensing unit by the actions of the top plate and the bottom plate of the mould.

As a further improvement to the technical solution, in step S3, the mould to which the nano-conductive rubber sensing unit is fixed is placed in a container at 60° C.

As a further improvement to the technical solution, the container is maintained in a vacuum state.

As a further improvement to the technical solution, in step S3, the mould to which the nano-conductive rubber sensing unit is fixed is placed in the container for at least 300 min.

The invention has the following beneficial effects.

1. According to the nano-conductive rubber sensing unit of the invention, by adding fabric layers as a frame, the compressive strength, tensile strength and fatigue resistance performance of the nano-conductive rubber sensing material are effectively improved, it is achieved that the nano-conductive rubber sensing unit has better sensitivity, linearity and stability of multiple cyclic loading within the measuring range of pressure intensity of 0 to 50 MPa, and the nano-conductive rubber sensing unit can be applied to a long-term pressure measurement in the state of a high pressure in the fields of mechanical manufacture, civil engineering, etc.

2. Under the effect of a vertical pressure, a resistance value measured by the nano-conductive rubber sensing unit increases with the increase of the pressure, showing a positive piezoresistance effect, which is different from the existing carbon-black filling type conductive rubber with negative piezoresistance effect. In addition, the linearity of a piezoresistance characteristic curve is good, and is suitable for manufacture of a high-accuracy pressure sensor.

3. The nano-conductive rubber sensing unit of the invention has the minimum thickness which can reach 3 mm, and can be suitable for pressure sensors of any curved surface and shape.

### BRIEF DESCRIPTION OF THE DRAWINGS

FIG. 1 is a schematic diagram of an integral structure of a nano-conductive rubber sensing unit according to the invention.

FIG. 2 is a cross-section microgram of the nano-conductive rubber sensing unit according to the invention (shot by using an optical microscope).

FIG. 3 is a test schematic diagram of the nano-conductive rubber sensing unit according to the invention.

FIG. 4 is a resistance-pressure intensity curve diagram in multiple loading of a prepared nano-conductive rubber sensing unit in the first embodiment of the invention.

FIG. 5 is a resistance-pressure intensity curve diagram in multiple loading of a prepared nano-conductive rubber sensing unit in the second embodiment of the invention.

FIG. 6 is a resistance-pressure intensity curve diagram in multiple loading of a prepared nano-conductive rubber sensing unit in the third embodiment of the invention.

### DETAILED DESCRIPTION OF THE EMBODIMENTS

The conception, specific structure and generated technical effects of the invention will be clearly and fully described below in combination with embodiments and drawings for one to fully understand the purposes, features and effects of the invention. Obviously, the described embodiments are some part of embodiments of the invention and are not all embodiments; and based on the embodiments of the invention, other embodiments obtained by those skilled in the art without contributing creative work will belong to the protection scope of the invention. In addition, all linkage/connection relationships concerned in the patent do not just mean that members are directly connected, but mean that a more excellent linkage structure can be formed by adding or reducing linkage auxiliaries according to specific implementation situations. Various technical features in the invention can be combined with each other on the premise of no mutual contradiction and conflict.

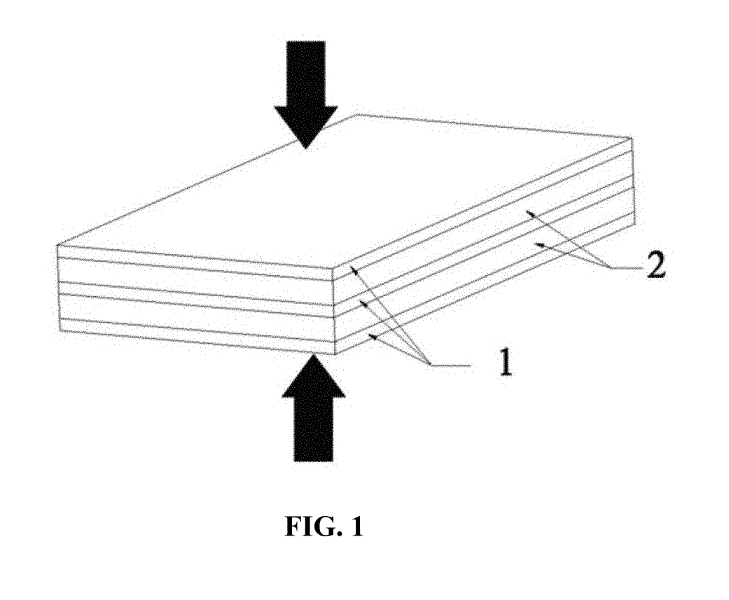

Referring to FIG. 1, the nano-conductive rubber sensing unit of the invention is of a multilayer structure, in which multiple high-strength fabric layers 1 serving as frame layers are distributed from top to bottom in a spaced relationship to one another with nano-conductive rubbers 2 of a certain thickness filled therebetween. The fabric layers 1 are compact in material tissue, have a certain thickness, elasticity and strength and meet the requirement of not being damaged when an elastic deformation occurs under the effect of a higher pressure. Moreover, gaps exist between textures formed by longitudinal and horizontal fibers of the fabric, so as to ensure that during the preparation process the nano-conductive rubber slurry covering thereon can penetrate into the gaps, thereby improving the integrity of the structure. The matrix material of the nano-conductive rubber 1 is silicone rubber (PDMS) which is formed by basic constituents and a curing agent in accordance with a mix proportion of 10:1. The conductive filler is carbon nanotubes, preferably, multi-wall carbon nanotubes (MWCNT), and the mass percent of the multi-wall carbon nanotubes is between 8% and 9%.

The fabric is formed by weaving elastic fibers (the higher the tex is, the thicker the fiber is) such as medium-tex or high-tex spandex, high-elasticity chinlon, etc., and the purpose of selecting large-sized yarns is to ensure that the fabric has a certain thickness to bear a pressing deformation. The elasticity of elastic fibers is required to have the following characteristics: (1) high elastic recovery percentage; (2) rapid resilience; (3) high elastic modulus (making a load required by extension thereof high). The calculation formula of the elastic recovery percentage is as follows:

elastic recovery percentage (%)=[(L₁−L′₁)/(L₁−L₀)]×100%,

where, L₀ is the original length of a sample; L₁ is the length when the sample is stretched to extension; and L′₁ is the length after recovery of the sample.

According to the invention, the high-strength fabric layers 1 are added as a strengthening frame of the nano-conductive rubber sensing unit, thereby significantly improving the strength and toughness of the nano-conductive rubber at a high pressure of 0 to 50 MPa. In the whole using process, no cracks are generated on the surface of the nano-conductive rubber sensing unit, let alone tearing, thereby ensuring the stability and repeatability of the sensing unit at a high pressure. Therefore, the nano-conductive rubber sensing unit can be used for manufacturing a sheet-type flexible nano-conductive rubber pressure sensor having a large measuring range.

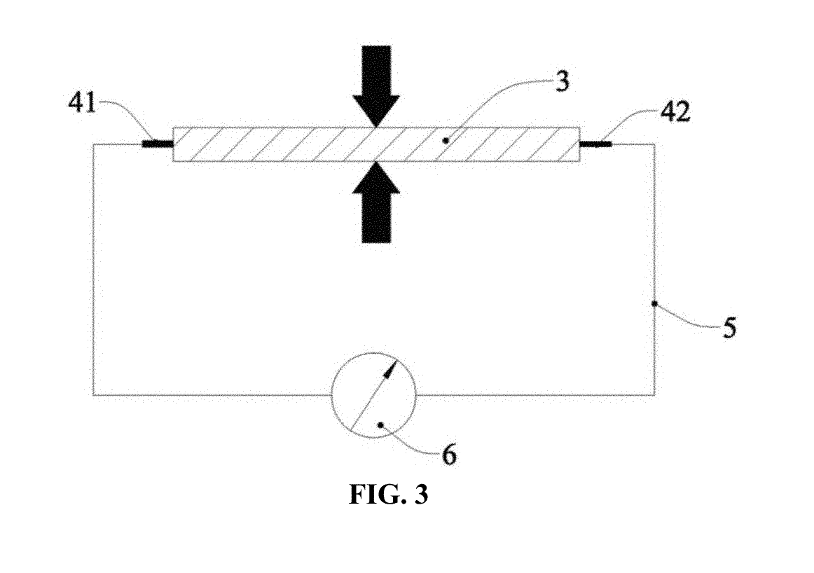

The nano-conductive rubber sensing unit according to the invention has the working principle that the sensing unit is of a sheet type in shape, when bearing the pressures of an upper surface and a lower surface (that is, pressures exerted in thickness directions of the sheet, i.e. the directions shown by arrows in FIG. 1 and FIG. 3), the sheet-type unit deforms under pressure, where in the deformation comprises compression in thickness directions and expansion in a sheet surface. The occurrence of the deformation may cause changes in a distance between the carbon nanotubes in the conductive rubber and lead to rearrangement of conductive network, these two changes may be represented by a change in the resistivity and resistance of the conductive rubber, causing a change in a measured electrical signal, and then, according to the piezoresistance characteristics of the conductive rubber, the stress state of a pressure-bearing surface can be obtained through reverse inference.

The nano-conductive rubber sensing unit of the invention is prepared mainly by a solution blending method and compression moulding, wherein the specific preparation method comprises the following steps:

S1, proportioning: weighing basic constituents of silicone rubber (PDMS), a curing agent and carbon nanotubes in accordance with a mass proportion, pouring the same into a mixer, and conducting mechanical grinding and mixing at room temperature to make sure that the carbon nanotubes are uniformly distributed in a rubber matrix, so as to make a nano-conductive rubber slurry;

S2, synthesizing: preparing many pieces of high-strength fabrics with the same size, laying flat one fabric layer on a bottom plate of a mould, spreading the nano-conductive rubber slurry prepared in S1 over the fabric uniformly to a certain thickness, and then, laying flat the other fabric layer thereon, wherein according to the thickness requirement of the nano-conductive rubber sensing element, spreading of the nano-conductive rubber slurry and a further laying of the fabric layer can be repeated successively; and

S3, curing: placing a top plate of the mold on the fabric layer located at the uppermost layer of the nano-conductive rubber sensing unit which is not cured, and exerting a certain pressure on a nano-conductive rubber material through the connection between the top plate and the bottom plate of the mold, thereby ensuring the thickness uniformity and compactness thereof; and placing the mold in a container at 60° C., evacuating the container such that a vacuum is created inside the container and keeping the mold in the container for at least 300 min.

After the nano-conductive rubber sensing unit is cured, in accordance with the design requirement of a sensor, the cured sheet-type nano-conductive rubber sensing unit can be cut to a required size and shape by using a machining cutter, and then is connected to an upper electrode and an insulating protective layer so as to complete the manufacture of a sheet-type flexible nano-conductive rubber pressure sensor having a large measuring range.

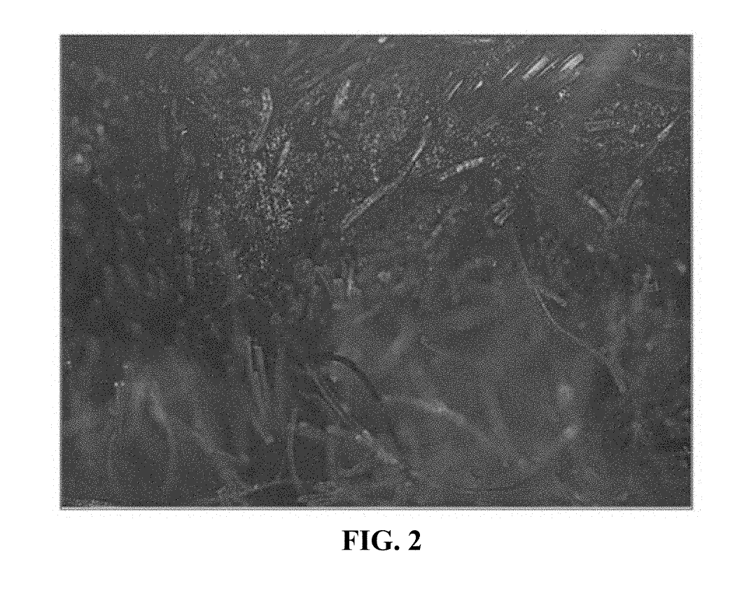

FIG. 2 is a cross-section microgram of the nano-conductive rubber sensing unit according to the invention, and from the figure, it can be seen that: (1) the fabric serves as a frame in the conductive rubber, thereby improving the strength of the whole sensing unit; (2) the elastic fabric has higher elastic modulus relative to the conductive rubber, thereby improving the resilience of the whole structure, the elastic recovery percentage thereof after compressive deformation is increased, and an inherent resilience delay of the rubber is offset by the rapid resilience of the elastic fibers; and (3) in the case of large pressure, due to the fact that it is difficult to assure absolute flatness of a contact surface as well as the composition segregation of rubber itself, the conductive rubber is prone to stress concentrations and cracks, and thus fails as a result. However, in this structure, a soft fabric can effectively avoid stress concentrations, and can ensure a certain thickness at a large pressure. The gap between fibers provides a space for the existence of the conductive rubber, which has great significance in achieving the measurement at a high pressure.

FIG. 3 is a test schematic diagram of the nano-conductive rubber sensing unit according to the invention. As shown in FIG. 3, a sensing unit 3 bears a pressure shown by an arrow, a left measuring electrode 41 and a right measuring electrode 42 located at the left and right sides of the sensing unit 3 are electrically connected to an ohmmeter 6 through conducting wires 5, and under the effect of the pressure, the sensing unit 3 generates a deformation, and the resistance increases, thereby showing a positive piezoresistance effect.

### Embodiment 1

In accordance with a mass ratio, there are 100 shares of basic constituents of silicone rubber (PDMS), 10 shares of curing agent and 9.57 shares of double-wall carbon nanotubes, wherein the mass percent of the double-wall carbon nanotubes in a nano-conductive rubber mixed solution is 8%, and for fabrics, a cloth with a suitable thickness, elasticity and strength which is commercially-available is selected. The prepared nano-conductive rubber sensing unit is in the shape of a square of which the side length is 50 mm and the thickness is 3 mm, in which there are two fabric layers which are respectively located on the upper surface and the lower surface of the sensing unit. There is one conductive rubber layer, which is located between an upper fabric layer and a lower fabric layer and has a thickness of about 1 mm.

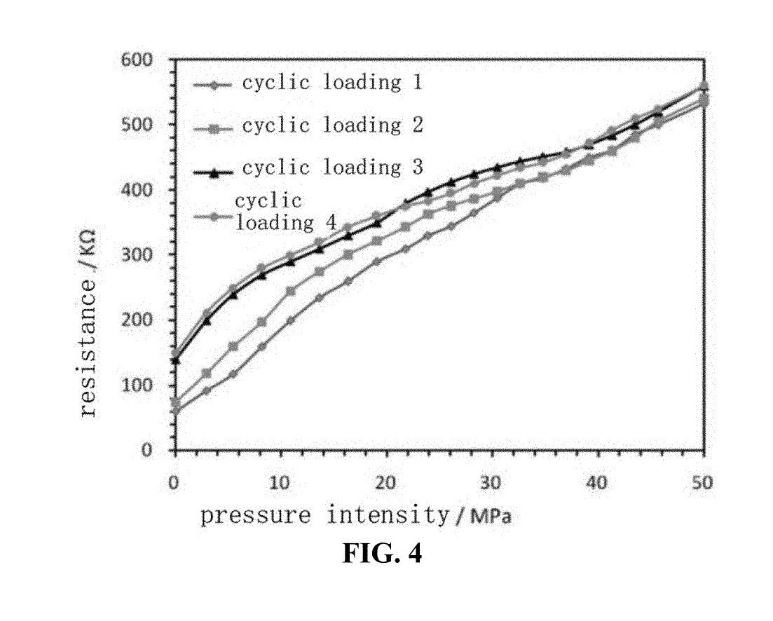

FIG. 4 shows resistance-pressure intensity change curves in four cyclic loading of a prepared nano-conductive rubber sensing unit in embodiment 1 of the invention, which are obtained in accordance with a test method of FIG. 3. It can be seen from FIG. 4 that the sensing unit has good sensitivity, linearity and stability within the pressure intensity range of 0 to 50 MPa, conforming to the material requirement of manufacturing a pressure sensor.

### Embodiment 2

In accordance with a mass ratio, there are 100 shares of basic constituents of silicone rubber (PDMS), 10 shares of curing agent and 10.22 shares of double-wall carbon nanotubes, wherein the mass percent of the double-wall carbon nanotubes in a nano-conductive rubber mixed solution is 8.5%, and for fabrics, a cloth with a suitable thickness, elasticity and strength which is commercially-available is selected. The prepared nano-conductive rubber sensing unit is in the shape of a square of which the side length is 50 mm and the thickness is 3 mm, in which there are two fabric layers which are respectively located on the upper surface and the lower surface of the sensing unit. There is one conductive rubber layer, which is located between an upper fabric layer and a lower fabric layer and has a thickness of about 1 mm.

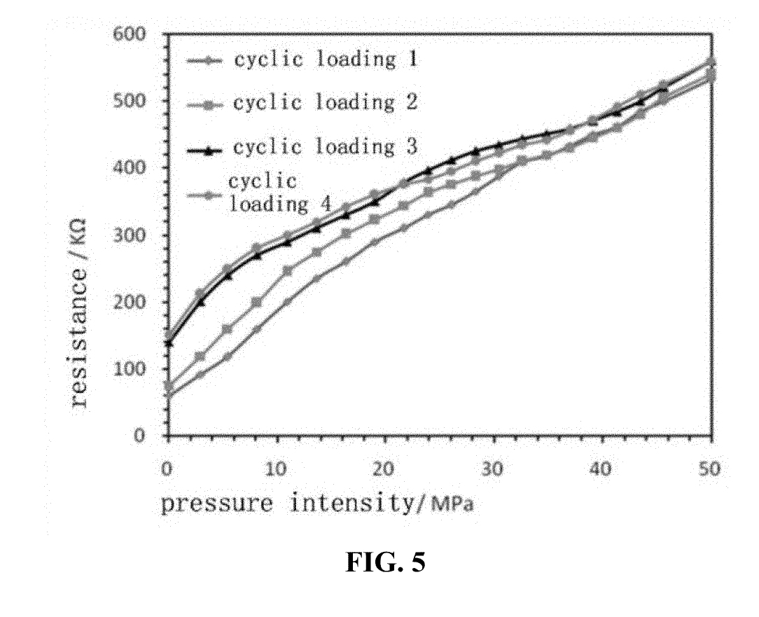

FIG. 5 shows resistance-pressure intensity change curves in four cyclic loading of a prepared nano-conductive rubber sensing unit in embodiment 2 of the invention, which are obtained in accordance with a test method of FIG. 3. It can be seen from FIG. 5 that the sensing unit has good sensitivity, linearity and stability within the pressure intensity range of 0 to 50 MPa, conforming to the material requirement of manufacturing a pressure sensor.

### Embodiment 3

In accordance with a mass ratio, there are 100 shares of basic constituents of silicone rubber (PDMS), 10 shares of curing agent and 10.88 shares of double-wall carbon nanotubes, wherein the mass percent of the double-wall carbon nanotubes in a nano-conductive rubber mixed solution is 9%, and for fabrics, a cloth with a suitable thickness, elasticity and strength which is commercially-available is selected. The prepared nano-conductive rubber sensing unit is in the shape of a square of which the side length is 50 mm and the thickness is 3 mm, in which there are two fabric layers which are respectively located on the upper surface and the lower surface of the sensing unit. There is one conductive rubber layer, which is located between an upper fabric layer and a lower fabric layer and has a thickness of about 1 mm.

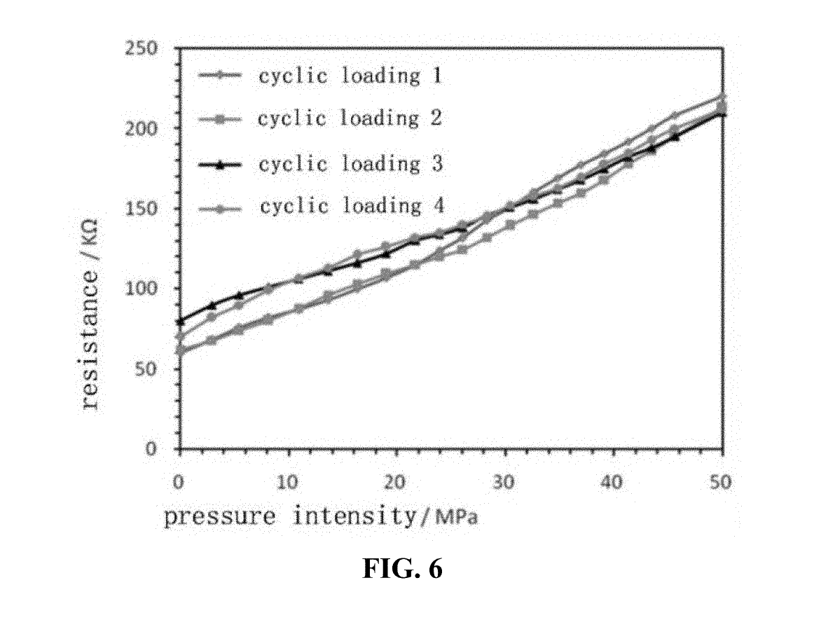

FIG. 6 shows resistance-pressure intensity change curves in four cyclic loading of a prepared nano-conductive rubber sensing unit in embodiment 3 of the invention, which are obtained in accordance with a test method of FIG. 3. It can be seen from FIG. 6 that the sensing unit has good sensitivity, linearity and stability within the pressure intensity range of 0 to 50 MPa, conforming to the material requirement of manufacturing a pressure sensor.

According to the invention, multiple layers of fabrics are adopted as frame layers, and are closely combined with nano-conductive rubber through a specific process, and the nano-conductive rubber is infiltrated into gaps in the fabrics, so as to form a stable whole. The fabric layers have good elasticity, toughness and tensile strength, can generate an elastic deformation together with the conductive rubber layer to meet the requirements of the deformation of the sensing unit, and can also limit excessive deformation of the sensing unit to protect the conductive rubber layer from being torn at a high pressure, so that the mechanical strength of the sensing unit within a pressure sensitive range is effectively improved, and the sensing unit will not be damaged even if it undergoes repeated loading and unloading under the effect of a higher pressure, thereby having good stability and repeatability and meeting the requirement of manufacturing a pressure sensor with a high measuring range and a high resistance to pressure.

The above are preferred embodiments of the invention, but the invention is not limited thereto. Those skilled in the art can make various equivalent modifications or replacements without departing from the spirit of the invention. All such equivalent modifications or replacements should fall within the scope defined by the claims of the invention.

1. A nano-conductive rubber sensing unit, comprising two or more fabric layers, wherein:
a nano-conductive rubber is sandwiched between each two adjacent fabric layers;
fiber texture gaps of the fabric layers are filled with the nano-conductive rubber;
the nano-conductive rubber is a rubber matrix in which carbon nanotubes are uniformly dispersed;
the carbon nanotubes are multi-wall carbon nanotubes;
the thickness of the nano-conductive rubber is not less than 1 mm;
the nano-conductive rubber is a slurry before curing;
the fabric layers comprise fabric and yarns;
the yarns located at two sides of the sensing unit act as electrodes; and
the fabric layers are added as a strengthening frame of the nano-conductive rubber sensing unit.

2. (canceled)

3. The nano-conductive rubber sensing unit according to claim 2, characterized in that the mass percent of the multi-wall carbon nanotubes in the nano-conductive rubber is between 8% and 9%.

4. (canceled)

5. The nano-conductive rubber sensing unit according to claim 1, characterized in that the rubber matrix is silicone rubber, and the proportion of basic constituents of the silicone rubber to a curing agent is 10:1.

6. A method of making a nano-conductive rubber sensing unit, comprising:
a) mixing rubber basic constituents, a curing agent and carbon nanotubes and conducting mechanical grinding to make a nano-conductive rubber slurry;
b) spreading the nano-conductive rubber slurry over a first fabric layer and placing a second fabric layer thereon to form a nano-conductive fabric laminate; and
c) pressurizing and heating the nano-conductive fabric laminate to cure the same;
wherein:
in step b), the first fabric layer is laid flat on a bottom plate of a mold, and a top plate of the mold is placed on the second fabric layer; and
in step c), pressure is exerted on the nano-conductive fabric laminate by the actions of the top plate of the mold and the bottom plate of the mold.

7. (canceled)

8. The method of claim 6, characterized in that:
in step c), the mold is placed in a container at 60° C. while pressure is exerted on the nano-conductive fabric laminate.

9. The method of claim 8, wherein the container is maintained in a vacuum state while pressure is exerted on the nano-conductive fabric laminate.

10. The method of claim 9, characterized in that:
in step c), the mold is placed in the container until the nano-conductive rubber sensing unit is cured while pressure is exerted on the nano-conductive fabric laminate.

11. The method of claim 6, wherein fiber texture gaps of the fabric layers are filled with the nano-conductive rubber slurry.
